(19) United States
(12) Patent Application Publication
(10) Pub. No.: US 2024/0051043 A1
(43) Pub. Date: Feb. 15, 2024

(54) MICRO FORM END MILL

(71) Applicant: ZECHA HARTMETALL-WERKZEUGFABRIKATION GMBH, Koenigsbach-Stein (DE)

(72) Inventors: Martin RUCK, Ispringen (DE); Thilo Hutmacher, Koenigsbach-Stein (DE)

(21) Appl. No.: 18/266,844

(22) PCT Filed: Dec. 18, 2020
(86) PCT No.: PCT/EP2020/087238

§ 371 Date: Jun. 13, 2023

(51) Int. Cl. B23C 5/10

(52) U.S. Cl. CPC B23C 5/10; B23C 2210/084; B23C 2210/0421; B23C 2210/203; B23C 2210/285

(57) ABSTRACT

A micro form end mill includes a tool shank (2) and a cutting head (3) fixedly connected to the tool shank (2). The cutting head (3) has a plurality of cutting teeth (Z), and each of the plurality of cutting teeth (Z) has a cutting edge (S). A maximum radial distance (Aₘₐₓ) of cutting points (6, 7, 8, 9) on the cutting edge (S) from the longitudinal axis (L) is less than 0.5 mm. At least two of the cutting edges (S) are arranged with a radial offset (V) from one another at least regionally. The radial offset (V) corresponds to a difference in the radial distances from the longitudinal axis (L) of such cutting points (6, 7, 8, 9) to the at least two cutting edges (S) that lie in a common plane (E) that is perpendicular to the longitudinal axis (L).

### CROSS-REFERENCE

This application is the U.S. national stage of International Application No. PCT/EP2021/060277 filed on Dec. 18, 2020.

### TECHNICAL FIELD

The present invention relates to a form end mill for milling workpieces in the micron range.

### RELATED ART

In recent years, innovative products such as bipolar plates for fuel cells have increased the need for smaller and smaller components and have placed increasingly stringent requirements on the dimensional accuracy and surface roughness of these components.

Concomitantly, the need for ever smaller components places stringent requirements on the tools used to manufacture these components.

Due to this, a need for micro end mills has been created in the field of milling tools. End mills having a tool diameter smaller than 1 mm will be referred to as micro end mills. The machining conditions of micro end mills cannot be compared with the machining conditions of a larger end mill having a tool diameter of, for example, 3 mm, 4 mm or 6 mm. Therefore, the geometry for a micro end mill cannot be determined (designed) by simply scaling down the geometry of the larger end mill.

Chamfer end mills having tool diameters in the range of 0.4 mm to 3 mm are known from the firm 6C Tools. For example, the chamfer end mill from the firm 6C Tools having the part number CM-P-1045-030-020 has eight cutting teeth, each having one cutting edge. The cutting edges have a maximum diameter of 3.0 mm and a minimum diameter of 2.0 mm. The cutting edges extend at a constant attack angle of 45°.

### SUMMARY

In view of the above circumstances, it is one non-limiting object of the present teachings to disclose techniques for improving, in comparison to known end mills, the dimensional accuracy and surface roughness in the manufacture of components in the micron range.

In one non-limiting aspect of the present teachings, a micro form end mill (micro contouring end mill) for the manufacture of forming tools in tool- and mold-making, for example, for the formation of fuel cell components is disclosed. The micro form end mill comprises a tool shank, which is designed to be received in a tool holder of a milling machine, and a cutting head, which is fixedly connected to the tool shank. The tool shank and the cutting head have a common longitudinal axis about which the micro form end mill rotates during usage. The cutting head has a plurality of cutting teeth and each of the plurality of cutting teeth has a cutting edge. A maximum distance from any (all) of the cutting points on the cutting edge to the longitudinal axis is less than 0.5 mm. At least two cutting edges are arranged with a radial offset from each other at least regionally. This radial offset corresponds to a difference in distances from the longitudinal axis of such cutting points to the at least two cutting edges that lie in a common plane that is perpendicular to the longitudinal axis.

One concept underlying the present teachings is to adjust and tune the engagement (cutting) conditions of cutting edges of the plurality of cutting teeth of a micro form end mill such that a workpiece can be machined to achieve a uniform and optimal dimensional accuracy using the micro form end mill.

The engagement conditions are adjusted by changing the radial offset of the plurality of cutting edges with respect to each other.

By utilizing the present teachings, a prefinishing effect can be achieved during workpiece machining. That is, because the cutting edges are offset radially inwards towards the longitudinal axis, the final contour of the workpiece to be machined can be prefinished. The radially outermost cutting edges create the final contour on the workpiece.

Cutting edges can be offset over the entire cutting edge length or can have an offset only regionally. Accordingly, the final contour also can be created by the outermost regions of different cutting edges.

Owing to the offset of the cutting edges, not all cutting edges of the micro form end mill lie on the outer envelope curve. Rather, some of the cutting edges are set back somewhat in accordance with the position on the tool and the wrapping around at the component. The envelope curve designates (means) the enveloping surface of all paths of any (all) of the cutting points that rotate around the longitudinal axis during usage of the micro form end mill. The envelope curve is thus formed by the points that are spaced the greatest radial distance from the longitudinal axis, wherein points of a common plane perpendicular to the longitudinal axis are respectively considered. This design prevents chatter marks and ensures better surface quality of the component that is manufactured by machining. For example, the cutting edges in the anterior region of the cutting head can be arranged so that the cutting edges of all cutting teeth lie on the outer envelope curve, whereas the cutting edges in the posterior region of the cutting head can be arranged so that only some of the cutting edges (i.e. on some of all of the cutting teeth) lie on the outer envelope curve.

Commensurate with the very small distances of any (all) of the cutting points on the cutting edge from the longitudinal axis, micro form end mills according to the present teachings are suitable for the precision milling of very small workpieces, such as forming tools in tool- and mold-making, for example, for the formation of fuel cell components.

Preferably, the cutting teeth are formed integrally with the cutting head. Preferably, the cutting head is manufactured from a polycrystalline diamond (PCD) blank using laser technology. Material can be removed by laser ablation until the desired geometry of the cutting edge of the respective cutting teeth remains on the cutting teeth.

According to a preferred embodiment, at least one cutting edge extends from a minimum distance at a cutting edge start, which faces towards (is adjacent or proximal to) the exposed (terminal) end of the cutting head, to the maximum distance at a cutting edge end, which faces towards (is adjacent or proximal to) the tool shank, such that the at least one cutting edge has an S-shaped segment. The S-shaped segment preferably includes, as viewed from the cutting edge start in the direction towards the cutting edge end: a first curved region, in which the attack (approach) angles of the cutting edge change such that the cutting edge extends in a circular curved shape having a first radius, an intermediate region, in which the cutting edge extends at a constant attack angle, and a second curved region, in which the attack angles of the cutting edge change such that the cutting edge extends in a circular curved shape having a second radius. The attack angle of a cutting point is the angle between a tangent, which is tangent to the cutting edge at this cutting point, and a line parallel to the longitudinal axis that extends through this cutting point.

At least one cutting edge having an S-shaped segment can be used for the establishment of the radial offset of the cutting edges and for the improved adjustment of the engagement conditions.

The S-shaped segment of the at least one cutting edge makes it possible to adjust the spacing of cutting points along the cutting edge according to the requirements of the workpiece to be machined. Compared to a straight shape of the cutting edge, the S-shape enables that different cutting points along the cutting edge can have different attack angles.

Owing to the S-shape of one or more of the cutting edges, it is possible that a plurality of cutting edges will be arranged in relation to each other so that they extend offset from each other only regionally.

The cutting edge(s) can be formed only by the S-shaped segment. Alternatively, additional segments may be connected forward of the S-shaped segment and/or rearward of the S-shaped segment of the cutting edge, respectively. For example, first and second segments each having a constant attack angle may be provided forward of and rearward of the S-shaped segment, respectively, to connect the S-shaped segment to the cutting edge start and to the cutting edge end, respectively.

In another exemplary embodiment of the present teachings, the first curved portion of the S-shaped segment is curved away from the common longitudinal axis and the second curved portion is curved towards the common longitudinal axis.

Alternatively, the first curved region of the S-shaped segment may be curved towards the common longitudinal axis and the second curved region may be curved away from the common longitudinal axis, whereby the engagement conditions of the cutting points along the cutting edge can be adjusted to the workpiece being machined in another manner.

In another exemplary embodiment of the present teachings, the cutting edge lies in a plane in which the longitudinal axis also lies. The engagement conditions of the micro form end mill can be influenced thereby.

In another exemplary embodiment of the present teachings, the cutting edge lies in a plane that intersects the longitudinal axis. The engagement conditions of the micro shaping cutter can be influenced thereby.

In another exemplary embodiment of the present teachings, the wedge angle and/or clearance angle and/or rake angle of cutting points change along the cutting edge at least regionally.

The wedge angle can be variably adjusted in accordance with the distance and/or attack angle of cutting points along the cutting edge. Therefore, a uniform ablation along the cutting edge can be obtained and the best possible tool life can be achieved. The dimensional- and surface accuracy of the workpiece to be machined using the micro form end mill can be met more precisely.

Furthermore, based on modified engagement conditions for different milling tasks, the rake and clearance angles can be adjusted along the cutting edge. The engagement conditions include, in particular, the cutting depth aₚ, the cutting width aₑ, the feed per tooth f_{z}, the cutting speed v_{c} and the distance of cutting points on the cutting edge to the longitudinal axis.

As a result, for example, a large rake angle can be expedient in the region of smaller distances of cutting points from the longitudinal axis and for outer radii of the cutting edge, i.e. radii which are curved away from the longitudinal axis, whereas a small or negative rake angle is expedient for inner radii of the cutting edge, i.e. radii which are curved towards the longitudinal axis, and in the region of larger distances of cutting points from the longitudinal axis.

In another exemplary embodiment of the present teachings, the cutting head comprises at least 4, more particularly 8 to 12, cutting teeth, which are preferably distributed uniformly (equispaced) around the circumference of the cutting head.

The cutting edges are the wear part of the micro form end mill. The more cutting edges the micro form end mill has, the more cutting edges share the wear and the longer the tool life. Moreover, a micro form end mill having a plurality of cutting edges runs “smoother” than one having only one cutting edge. With a plurality of cutting edges, a smoother surface can be realized on the workpiece being machined.

Furthermore, owing to the utilization of many cutting edges, the engagement time of the cutting edges is greatly reduced, whereby polycrystalline diamond (PCD) tools with steel can be used for finishing without a problem.

In another exemplary embodiment of the present teachings, the cutting head has a group of at least two successive cutting teeth (i.e. successive in a circumferential direction of the cutting head), wherein the cutting edges of the successive cutting teeth are arranged radially offset from each other at least regionally. This group of at least two successive cutting teeth repeats itself at least once in the circumferential direction of the cutting head.

Owing to the partial offset of cutting edges and the circumferentially repeating sequence of a group of cutting teeth having a plurality of cutting edges that are offset relative to each other, smoother running of the tool and higher surface quality during milling can be achieved.

Furthermore, it is possible to design the geometry of the cutting head such that a radial offset of cutting edges is present in the posterior regions of the cutting edges, where the distances of cutting points on the cutting edge from the longitudinal axis are large. On the other hand, no radial offset of cutting edges is present in the anterior region of the cutting edges, in which the distances of cutting points on the cutting edge from the longitudinal axis are small.

In an embodiment having a total of twelve cutting edges, each having an S-shaped segment, the cutting edges can be arranged, for example, so that no offset of cutting edges exists in the anterior region of the cutting edges, in which the distances of cutting points from the longitudinal axis are smaller, whereas only four cutting edges lie on the outer envelope curve in the posterior region of the cutting edges, in which the distances of cutting points from the longitudinal axis are larger. Thus, the number of teeth whose cutting edge lies on the outer envelope curve is reduced from twelve in the region of the cutting edge start to four cutting points in the region of the cutting edge end.

Preferably, the cutting edges on the cutting teeth are formed so that the ratio of feed per tooth to the effective diameters of the cutting edges along the cutting edges is in the range of 0.8%-1.5%. As a result, the load on the cutting edges is as constant as possible along the cutting edge from the cutting edge start to the cutting edge end. The effective diameter of a cutting point corresponds to twice the distance of this cutting point from the longitudinal axis. The effective diameter of cutting points along a cutting edge increases along the longitudinal axis from anterior to posterior.

In another exemplary embodiment of the present teachings, the minimum distance of the cutting edge in the region of the first curved region (I) is in the range of 0.1-0.3 mm and the maximum distance of the cutting edge in the region of the second curved region (III) is in the range of 0.3-0.5 mm. Further, the first radius of the first curved region is in the range of 0.005 mm-0.25 mm and the constant attack angle in the intermediate region of the S-shaped segment is in the range of 0°-45°. Further, the second radius of the second curved region is in the range of 0.1 mm-0.25 mm, and the plurality of cutting edges are arranged radially offset from each other such that a maximum cutting edge offset (Vmax) is in the range of 0.001 mm-0.08 mm.

The design of the cutting edges according to the dimensions of this exemplary embodiment enables an optimal layout of the individual cutting edges as well as an optimal tuning of the plurality of cutting edges to each other, in which the regional offset of cutting edges leads to a pre-finishing effect and to a high dimensional accuracy and surface roughness of the workpiece after machining.

According to another non-limiting aspect of the present teachings, a micro form end mill for the manufacture of forming tools in tool- and mold-making, for example, for the formation of fuel cell components, is disclosed. The micro form end mill comprises at least one cutting edge, which extends from a minimum (radial) distance at a cutting edge start, which faces towards (is adjacent or proximal to) the exposed (terminal) end of the cutter head, to a (radial) maximum distance at a cutting edge end, which faces towards (is adjacent or proximal to) the tool shank such that the at least one cutting edge has an S-shaped segment. The S-shaped segment preferably includes, as viewed from the cutting edge start in the direction towards the cutting edge end: a first curved region, in which the attack angles of the cutting edge change such that the cutting edge extends in a circular curved shape having a first radius, an intermediate region, in which the cutting edge extends at a constant attack angle, and a second curved region, in which the attack angles of the cutting edge change such that the cutting edge extends in a circular curved shape having a second radius. The attack angle of a cutting point is the angle between a tangent line, which is tangent to the cutting edge at that cutting point, and a line parallel to the longitudinal axis that extends through that cutting point.

### BRIEF DESCRIPTION OF THE DRAWINGS

Exemplary embodiments of the present teachings are described and explained in more detail below with reference to the accompanying figures.

FIG. 1 shows a side view of a micro form end mill according to one representative embodiment of the present teachings.

FIG. 2 shows a front view of the cutting head of the micro form end mill shown in FIG. 1.

FIG. 3 shows a cross-sectional view of the cutting tooth Z1 of the cutting head shown in FIG. 2 along the cross-section B-B, wherein the cross-sectional plane is arranged such that the cross-sectional plane contains the longitudinal axis of the cutting head and the cutting edge S1 of the shown cutting tooth Z1.

FIG. 4 shows the cross-sectional views of the cutting teeth Z1-Z12 of the cutting head shown in FIG. 2, wherein three cross-sectional views are each shown in superimposed form, and the plurality of cross-sectional planes is arranged such that each of the plurality of cross-sectional planes contains the longitudinal axis of the cutting head and the cutting edge S1-S12 of the respective shown cutting tooth Z1-Z12.

FIG. 5 shows the cross-sectional views of twelve cutting teeth Z1-Z12 of another cutting head according to the present teachings, wherein the cross-sectional views are shown in superimposed form and the plurality of cross-sectional planes is arranged such that each of the plurality of cross-sectional planes contains the longitudinal axis of the cutting head and the cutting edge S1-S12 of the respective shown cutting tooth Z1-Z12.

FIG. 6 shows a side view of a cutting head according to another representative embodiment according to the present teachings.

### DETAILED DESCRIPTION OF THE INVENTION

The direction along the longitudinal axis is hereinafter referred to as the forward-rearward direction and/or as the longitudinal direction. The side of the micro form end mill on which the cutting head is located is referred to as the anterior side of the micro form end mill. The side on which the tool shank is located is referred to as the posterior side of the micro shaper. The direction perpendicular to the longitudinal axis is referred to as the radial direction.

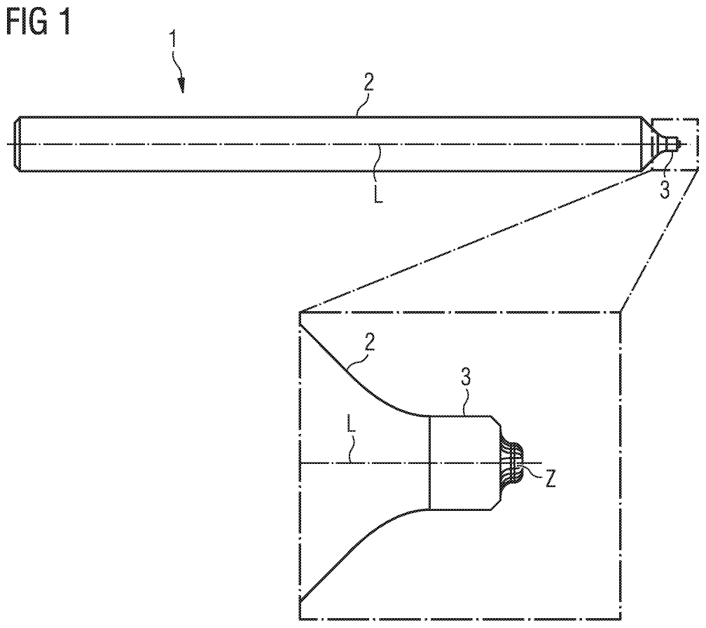

FIG. 1 shows a side view of an exemplary micro form end mill (micro contouring end mill) 1 according to the present teachings. The micro form end mill 1 comprises a tool shank 2 and a cutting head 3. The cutting head 3 is fixedly connected to the tool shank 2. For example, the tool shank 2 and the cutting head 3 can be fixedly connected to each other by a solder joint. A plurality of cutting teeth Z is located in the anterior region of the cutting head 3. The tool shank 2 and the cutting head 3 have a common longitudinal axis L. During usage, the micro form end mill 1 rotates about this common longitudinal axis L. When using the micro form end mill shown in FIG. 1, the feed (movement direction of the micro form end mill) is perpendicular to the longitudinal axis L.

Preferably, the tool shank 2 is made of solid carbide (SC). Preferably, the cutting head 3 is made of polycrystalline diamond (PCD) or cubic boron nitride (CBN).

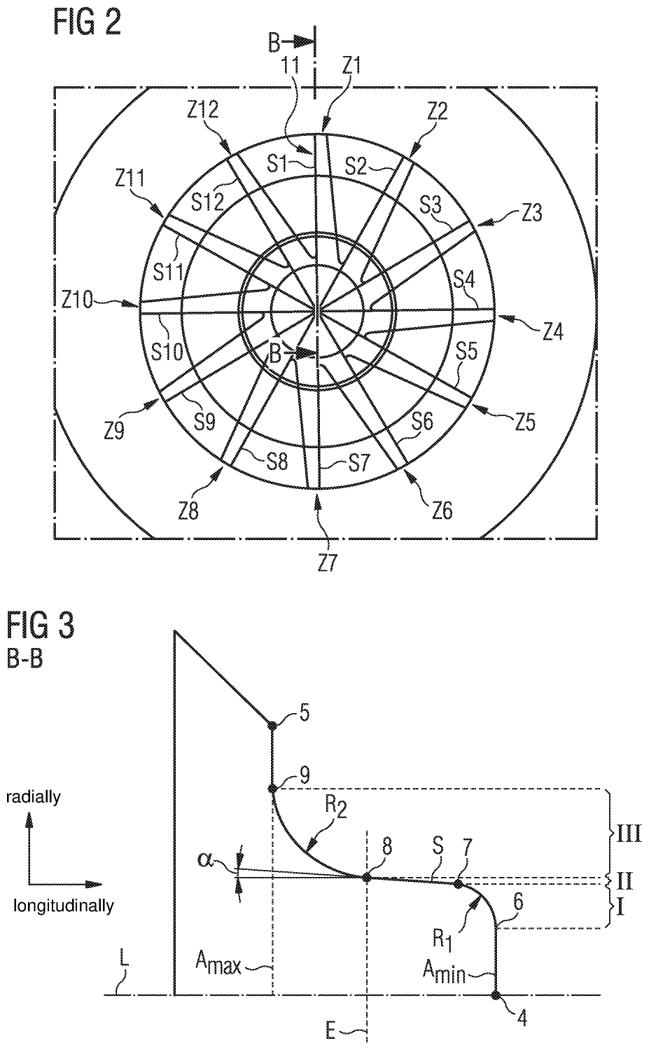

FIG. 2 shows a front view of the micro form end mill 1 shown in FIG. 1. The cutting head 3 comprises a total of twelve cutting teeth Z1 to Z12. Each of these cutting teeth Z1 to Z12 contains a cutting edge S1 to S12. These cutting edges S1 to S12 engage with (cut, ablate) the workpiece during usage of the micro form end mill 1. The micro form end mill 1 shown in FIG. 1 is designed to rotate counterclockwise during usage. In the shown embodiment of the micro form end mill 1, the cutting edges S1 to S12 extend straight, i.e. in the direction of the longitudinal axis, from anterior to posterior. The cutting edges S1 to S12 are arranged such that the cutting edge start of all the cutting edges is located at a common point on the longitudinal axis L.

According to modified embodiments according to the present teachings, the cutting edge may, in addition to or instead, extend obliquely or helically in the direction from anterior to posterior.

The rake face 11 may extend straight, obliquely or curved radially outwardly from the longitudinal axis L. The surface of the cutting tooth Z over which the cutting takes place during machining is referred to as the rake face 11.

FIG. 3 shows a cross-sectional view of the cutting tooth Z1 of the cutting head shown in FIG. 2 along the cross-section B-B, wherein the cross-sectional plane is arranged such that the cross-sectional plane contains the longitudinal axis of the cutting head and the cutting edge S1 of the shown cutting tooth Z1. The cutting edge S extends from a cutting edge start 4 to a cutting edge end 5. The cutting edge start 4 is located anterior of the cutting edge end 5. The distance A of cutting points 6, 7, 8, 9 on the cutting edge S from the longitudinal axis increases along the cutting edge S in the direction from anterior to posterior. The distance (Aₘₐₓ) of the cutting edge S from the longitudinal axis is greatest at (along) the cutting edge end 5. The distance (Aₘᵢₙ) of the cutting edge S from the longitudinal axis is the smallest at (along) the cutting edge start 4. In the present embodiment, the minimum distance (Aₘᵢₙ) from the longitudinal axis is 0 because the cutting edge S starts at the longitudinal axis L.

The cutting edge S has an S-shaped segment along the progression from the cutting edge start 4 to the cutting edge end 5. The S-shaped segment comprises a first curved region I, in which the attack angles α of the cutting edge S change such that the cutting edge S extends in a circular curved shape having a first radius R1. The circular curved shape is curved outward, i.e. away from the longitudinal axis L. The cutting points 6 and 7 are respectively located at the start and the end of the first curved segment I. In addition, the S-shaped segment includes an intermediate region II in which the cutting edge S extends with a constant attack angle α. The cutting points 7 and 8 are respectively located at the start and the end of the intermediate region II. In addition, the S-shaped segment comprises a second curved region III, in which the attack angles α of the cutting edge S change such that the cutting edge S extends in a circular curved shape having a second radius R2. The circular curved shape is curved inward, i.e., towards the longitudinal axis L. The cutting points 8 and 9 are respectively located at the start and the end of the second curved region III.

Both forward of the S-shaped segment (i.e. between cutting points 4 and 6) and rearward of the S-shaped segment of the cutting edge S (i.e. between cutting points 5 and 9), there is a region (segment) having a constant attack angle that connects the S-shaped segment to the cutting edge start 4 and to the cutting edge end 5, respectively.

The attack angle α is the angle between a tangent line, which is tangent to the cutting edge S at the cutting point 6, and a line parallel of the longitudinal axis L that extends through the cutting point 6.

In FIG. 3, E denotes a plane that is perpendicular to the longitudinal axis L and extends through the cutting point 8 on the cutting edge S.

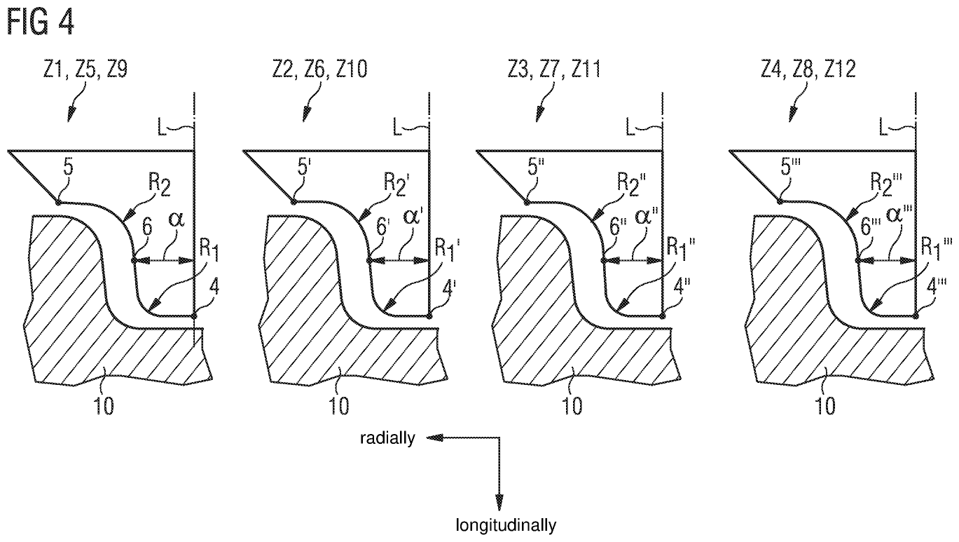

FIG. 4 shows the cross-sectional views of the cutting teeth Z1-Z12 of the cutting head shown in FIG. 2, wherein three cross-sectional views are each shown in superimposed form and the plurality of cross-sectional planes is arranged such that each of the plurality of cross-sectional planes contains the longitudinal axis L of the cutting head and the cutting edge S1-S12 of the respective shown cutting tooth Z1-Z12.

The cutting edges S1, S5 and S9 of the cutting teeth Z1, Z5 and Z9 are the same. The S-shaped segments of the cutting edges S1, S5 and S9 are characterized by the same radii R1, R2 of the first and second curved regions and the same attack angle α of the intermediate region.

The cutting edges S2, S6 and S10 of the cutting teeth Z2, Z6 and Z10 are the same. The S-shaped segments of the cutting edges S2, S6 and S10 are characterized by the same radii R1′, R2′ of the first and second curved regions and the same attack angle α′ of the intermediate region, wherein at least one of the radius R1′, the radius R2′ and the attack angle α′ is different from the corresponding sizes of the cutting edges S1, S5 and S9.

The cutting edges S3, S7 and S11 of the cutting teeth Z3, Z7 and Z11 are the same. The S-shaped segments of the cutting edges S3, S7 and S11 are characterized by the same radii R1″, R2″ of the first and second curved regions and the same attack angle α″ of the intermediate region, wherein at least one of the radius R1″, the radius R2″ and the attack angle α″ is different from the corresponding sizes of the cutting edges S1, S5 and S9.

The cutting edges S4, S8 and S12 of the cutting teeth Z4, Z8 and Z12 are the same. The S-shaped segments of the cutting edges S4, S8 and S12 are characterized by the same radii R1′″, R2′″ of the first and second curved regions and the same attack angle α′″ of the intermediate region, wherein at least one of the radius R1′″, the radius R2′″ and the attack angle α′″ is different from the corresponding sizes of the cutting edges S1, S5 and S9.

Due to the differences in the respective radii and the respective attack angles, the respective (given) cutting points 6, 6′, 6″ and 6′″, which are all located in a common plane perpendicular to the longitudinal axis L, may be spaced at different distances away from the longitudinal axis. The cutting edge starts 4, 4′, 4″ and 4′″ and the cutting edge ends 5, 5′, 5″ and 5′″ may be located at different points along the longitudinal axis L or may be spaced at different distances away from the longitudinal axis.

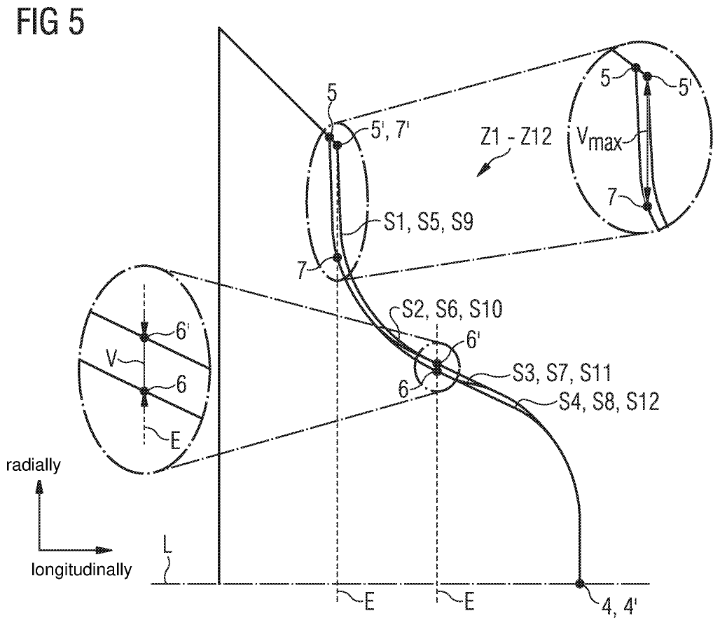

FIG. 5 shows the cross-sectional views of twelve cutting teeth Z1-Z12 of another exemplary cutting head according to the present teachings, wherein the cross-sectional views are shown in superimposed form and the plurality of cross-sectional planes is arranged such that the cross-sectional planes contain the longitudinal axis L of the cutting head and the cutting edge S1-S12 of the respective shown cutting tooth Z1-Z12.

The cutting edges S1, S5 and S9 are the same as each other. The cutting edges S2, S6 and S10 are the same as each other. The cutting edges S3, S7 and S11 are the same as each other. The cutting edges S4, S8 and S12 are the same as each other. However, these four groups of same cutting edges differ from each other, so that, for example, cutting edges S1, S2, S3, and S4 are not the same as each other.

Due to the dissimilar design of the respective cutting edges S1 to S12, not all cutting points of the plurality of cutting edges S1 to S12 have the same distance from the longitudinal axis L when they are located in a same plane E that is perpendicular to the longitudinal axis L. Rather, due to the dissimilar design of the respective cutting edges S1 to S12, a radial offset V between the cutting edges S1 to S12 results. The cutting (radial) offset V corresponds to the difference of the radial distances of cutting points on different cutting edges S1-S12 to the longitudinal axis L. Thus, e.g., the cutting points 6, 6′ lie in a common plane E that is perpendicular to the longitudinal axis.

With reference to the points from FIG. 5, the envelope curve is formed by the points (4,4′)-6′-(5′,7′), i.e. the points spaced apart by the greatest radial distance from the longitudinal axis in a plane E.

Cutting point 6 lies on one of the cutting edges of the group S3, S7, S11 or group S4, S8, S12. Cutting point 6′ lies on one of the cutting edges of the group S1, S5, S9 or group S2, S6, S10. Cutting point 6′ is spaced farther away from the longitudinal axis L than cutting point 6. The difference is the radial offset V.

Cutting point 7 lies on one of the cutting edges of the group S3, S7, S11 or group S4, S8, S12 or S2, S6, S10. The cutting point 7′ lies on one of the cutting edges of the group S1, S5, S9. It coincides with the cutting edge end 5′. Cutting point 7′ is spaced farther away from the longitudinal axis L than cutting point 7. The difference is the radial offset V, which in this case is the maximum radial offset Vmax.

Over their entire length, the cutting edges S1, S5 and S9 are spaced from the longitudinal axis L farther than the rest of the cutting edges or equally far away. Accordingly, the cutting edges S1, S5 and S9 determine the final contour on the workpiece to be machined.

According to a preferred embodiment, the cutting teeth Z1 to Z12 having the cutting edges S1 to S12 are arranged on the cutting head 3 such that dissimilar cutting edges S1 to S4 follow one another in the circumferential direction of the cutting head 3 and this sequence of dissimilar cutting edges S1 to S4 repeats itself in the circumferential direction. Accordingly, the sequence of dissimilar cutting teeth S5 to S8 follows cutting tooth S4 in this order, and cutting teeth S5 to S8 correspond to cutting teeth S1 to S4 in this order. Further, the sequence of dissimilar cutting teeth S9 to S12 follows cutting tooth S8 in this order, with cutting teeth S9 to S12 corresponding to cutting teeth S1 to S4 and cutting teeth S5 to S8, respectively, in this order.

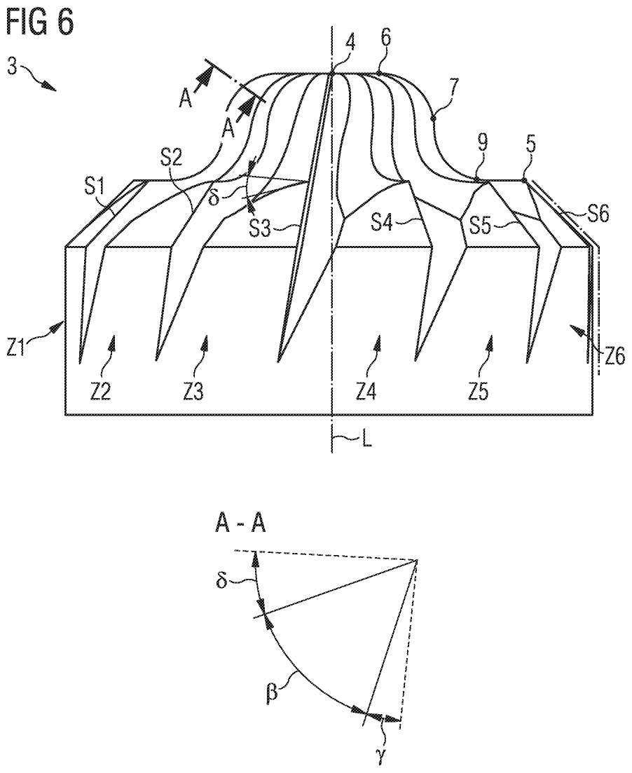

FIG. 6 shows a side view of a cutting head according to another exemplary embodiment according to the present teachings. Compared to the other exemplary embodiments, the cutting edges comprise two additional segments at the cutting edge end, each of which has a constant attack angle α. These regions are manufacturing-related, non-cutting extensions of the cutting edge.

Using a micro form end mill according to the present teachings, workpieces can be machined in the micro range and the strictest requirements for dimensional accuracy and surface roughness can be met.

For example, micro form end mills according to the present teachings can be used to manufacture forming tools in tool- and mold-making, which are used to manufacture fuel cell components. In particular, micro form end mills according to the present teachings can be used for contour finishing during finishing for such forming tools. The component height of such forming tools is generally less than 0.5 mm and the surfaces between the lateral contours are at most 0.6 mm. The requirements placed on the components in terms of dimensional accuracy and surface roughness Ra are very high. The dimensional accuracy is preferably in the range less than 0.003 mm and the surface roughness Ra is preferably in the range less than 0.2 μm.

### REFERENCE SYMBOL LIST

1 Micro form end mill
2 Tool shank
3 Cutting head
4, 4′, 4″, 4′″ Cutting edge start
5, 5′, 5″, 5′″ Cutting edge end
6, 6′, 7, 7′, 8, 9 Cutting points
10 Workpiece
11 Rake face
12 Main clearance surface
α, α′, α″, α′″ Attack angle
β Wedge angle
δ Clearance angle
γ Rake angle
   Z, Z1-Z12 Cutting tooth
   S, S1-S12 Cutting edge
   A Distance
   Aₘᵢₙ Minimum distance
   Aₘₐₓ Maximum distance
   V Radial offset
   Vₘₐₓ Maximum radial offset
   L Longitudinal axis
   E Plane perpendicular to longitudinal axis L
   R1, R1′, R1″, R′″ Radius of the first circular curved shape
   R₂, R₂′, R₂″, R₂′″ Radius of the second circular curved shape
   I First curved region
   II Intermediate region
   III Second curved region

1. A micro form end mill, having:
a tool shank designed to be received in a tool holder of a milling machine, and
a cutting head fixedly connected to the tool shank such that the tool shank and the cutting head share a common longitudinal axis about which the micro form end mill rotates during usage,
wherein:
the cutting head has a plurality of cutting teeth and each of the plurality of cutting teeth has a cutting edge,
a maximum radial distance (Aₘₐₓ) from all cutting points on each of the cutting edges to the common longitudinal axis is less than 0.5 mm,
at least first and second ones of the cutting edges are arranged with a radial offset from one another,
wherein the radial offset is a difference in radial distances from the common longitudinal axis between a first one of the cutting points on the first one of the cutting edges and a first one of the cutting points on the second one of the cutting edges and the radial offset is present along only a portion of an entire length of the first and second ones of the cutting edges in a direction parallel to the common longitudinal axis,
said first one of the cutting points on the first one of the cutting edges and said first one of the cutting points on the second one of the cutting edges are intersected by a first common plane that is perpendicular to the common longitudinal axis, and
each of the plurality of cutting edges includes an S-shaped segment that extends radially from the common longitudinal axis from a minimum radial distance (Aₘᵢₙ), which is at a cutting edge start adjacent to a terminal end of the cutting head, to the maximum radial distance (Aₘₐₓ), which is at a cutting edge end adjacent to the tool shank.

2. The micro form end mill according to claim 1, wherein each of the S-shaped segments comprises, as viewed from the cutting edge start in the direction towards the cutting edge end,
a first curved region, in which attack angles (α) of the cutting edge change such that the cutting edge extends in a first circular curved shape having a first radius (R1),
an intermediate region, in which the cutting edge extends at a constant attack angle (α), and
a second curved region, in which the attack angles (α) of the cutting edge change such that the cutting edge extends in a second circular curved shape having a second radius (R2),
wherein each of the attack angles (α) of each of the cutting points is formed by a tangent line, which is tangent to the cutting edge at the cutting point, and a line parallel to the common longitudinal axis that extends through the cutting point.

3. The micro form end mill according to claim 2, wherein
the first curved region of each of the S-shaped segments is curved away from the common longitudinal axis and the second curved region is curved towards the common longitudinal axis.

4. The micro form end mill according to claim 1, wherein each of the cutting edges lies in respective planes in which the longitudinal axis also lies.

5. The micro form end mill according to claim 1, wherein each of the cutting edges lies in respective planes that each intersect the longitudinal axis.

6. The micro form end mill according to claim 1, wherein a wedge angle (β) and/or a clearance angle (δ) and/or a rake angle (γ) of the cutting points change(s) along at least a portion of the S-shaped segment of each of the cutting edges.

7. The micro form end mill according to claim 1, wherein the cutting head has at least four cutting teeth distributed uniformly around the circumference of the cutting head.

8. The micro form end mill according to claim 1, wherein:
the cutting head has a group of at least two successive cutting teeth,
the cutting edges (S1, S2) of the at least two successive cutting teeth are arranged radially offset from one another along at least a portion of the S-shaped segment of each of the cutting edges, and
said group of at least two successive cutting teeth repeats itself at least once in the circumferential direction of the cutting head.

9. The micro form end mill according to claim 2, wherein:
the minimum radial distance (Aₘᵢₙ) of each of the cutting edges in the first curved region is in the range of 0.1-0.3 mm and the maximum radial distance (Aₘₐₓ) of each of the cutting edges in the second curved region is in the range of 0.3-0.5 mm,
the first radius (R1) of the first curved region is in the range of 0.005 mm-0.25 mm,
the constant attack angle (α) in the intermediate region of the S-shaped segment is in the range of 0°-45°,
the second radius (R2) of the second curved segment is in the range of 0.1 mm-0.25 mm, and
the cutting edges are arranged radially offset from each other such that a maximum cutting edge offset (Vmax) is in the range of 0.001 mm-0.08 mm.

10. The micro form end mill according to claim 7, wherein the cutting head has eight to twelve of the cutting teeth distributed uniformly around the circumference of the cutting head.

11. The micro form end mill according to claim 3, wherein a wedge angle (β) and/or a clearance angle (δ) and/or a rake angle (γ) of the cutting points change(s) along at least a portion of the S-shaped segment of each of the cutting edges.

12. The micro form end mill according to claim 11, wherein the cutting head has at least four cutting teeth distributed uniformly around the circumference of the cutting head.

13. The micro form end mill according to claim 11, wherein the cutting head has eight to twelve of the cutting teeth distributed uniformly around the circumference of the cutting head.

14. The micro form end mill according to claim 13, wherein:
the minimum radial distance (Aₘᵢₙ) of each of the cutting edges in the first curved region is in the range of 0.1-0.3 mm and the maximum radial distance (Aₘₐₓ) of each of the cutting edges in the second curved region is in the range of 0.3-0.5 mm,
the first radius (R1) of the first curved region is in the range of 0.005 mm-0.25 mm,
the constant attack angle (α) in the intermediate region of the S-shaped segment is in the range of 0°-45°,
the second radius (R2) of the second curved segment is in the range of 0.1 mm-0.25 mm, and
the cutting edges are arranged radially offset from each other such that a maximum cutting edge offset (Vmax) is in the range of 0.001 mm-0.08 mm.

15. The micro form end mill according to claim 14, wherein:
a second one of the cutting points on the first one of the cutting edges is located outside of the portion of the entire length of the first and second ones of cutting edges in the direction parallel to the common longitudinal axis having the radial offset,
a second one of the cutting points on the second one of the cutting edges is located outside of the portion of the entire length of the first and second ones of cutting edges in the direction parallel to the common longitudinal axis having the radial offset,
said second one of the cutting points on the first one of the cutting edges and said second one of the cutting points on the second one of the cutting edges are intersected by a second common plane that is perpendicular to the common longitudinal axis and is parallel to the first common plane, and
the radial distance of said second one of the cutting points on the first one of the cutting edges is equal to the radial distance of said second one of the cutting points on the second one of the cutting edges.

16. The micro form end mill according to claim 1, wherein:
a second one of the cutting points on the first one of the cutting edges is located outside of the portion of the entire length of the first and second ones of cutting edges in the direction parallel to the common longitudinal axis having the radial offset,
a second one of the cutting points on the second one of the cutting edges is located outside of the portion of the entire length of the first and second ones of cutting edges in the direction parallel to the common longitudinal axis having the radial offset,
said second one of the cutting points on the first one of the cutting edges and said second one of the cutting points on the second one of the cutting edges are intersected by a second common plane that is perpendicular to the common longitudinal axis and is parallel to the first common plane, and
the radial distance of said second one of the cutting points on the first one of the cutting edges is equal to the radial distance of said second one of the cutting points on the second one of the cutting edges.
